(19) United States
(12) Patent Application Publication
(10) Pub. No.: US 2026/0091609 A1
(43) Pub. Date: Apr. 2, 2026

(54) IMAGING DURING ICE CREATION

(71) Applicant: Drama Llama Mamas, LLC, Cedar Park, TX (US)

(72) Inventor: Steven Adams, Cedar Park, TX (US)

(21) Appl. No.: 18/904,593

(22) Filed: Oct. 2, 2024

(51) Int. Cl. B41M 3/00; A23P 20/20; F25C 5/00

(52) U.S. Cl. CPC B41M 3/00; A23P 20/20; F25C 5/00; F25C 2400/00

(57) ABSTRACT

A system includes an imaging system, and a freezing chamber coupled to the imaging system. The system further includes a tray coupled to the freezing chamber. The freezing chamber creates ice from water by freezing the water in the tray, and the imaging system places an image into the tray during ice creation such that the ice includes the image.

### BACKGROUND

In the field of ice production, there has traditionally been little innovation beyond the basic ice-making processes of freezing water. However, there is an increasing demand for unique and customizable ice products, especially in settings where presentation and visual appeal are important, such as in bars, restaurants, hotels, and private events. Conventional ice-making methods do not offer the ability to personalize or enhance the visual appearance of ice, limiting the opportunities for businesses and individuals to create memorable experiences with their ice and corresponding beverages.

### SUMMARY

A system includes an imaging system, and a freezing chamber coupled to the imaging system. The system further includes a tray coupled to the freezing chamber. The freezing chamber creates ice from water by freezing the water in the tray, and the imaging system places an image into the tray during ice creation such that the ice includes the image.

A method includes receiving a digital image and printing the digital image, thus creating a printed image. The method further includes automatically feeding the printed image into a tray. The tray is coupled to a freezing chamber that creates ice from water by freezing the water in the tray during ice creation such that the ice includes the image.

A system includes a means for imaging and a means for freezing water coupled to the imaging means. The system further includes a means for holding water coupled to the freezing means. The freezing means creates ice from water by freezing the water in the holding means, and the imaging means places an image into the holding means during ice creation such that the ice includes the image.

### BRIEF DESCRIPTION OF THE DRAWINGS

Systems and methods for imaging during ice creation are disclosed herein. In the drawings:

FIG. 1 is a diagram of the system in accordance with at least one illustrated embodiment; and

FIG. 2 is a flowchart of the method in accordance with at least one illustrated embodiment.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### NOTATION AND NOMENCLATURE

Certain terms are used throughout the following description and claims to refer to particular system components and configurations. As one of ordinary skill will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”.

### DETAILED DESCRIPTION

Disclosed herein are systems and methods for ice creation that allow for insertion of images into the ice during the ice-making process. The systems and methods can be used for both commercial and personal use, and the image insertion feature adds a unique and visually appealing aspect to drinks and beverages that use the ice. The systems and methods can be used in a variety of settings such as bars, restaurants, hotels, and at home. For example, sporting venues may offer drinks that contain ice featuring the logo of the home team. At home, a user may seasonally change the images in their ice maker in accordance with the next upcoming holiday or birthday. These are just two examples of the many uses enabled by this disclosure. Additionally, the ice may be made with water or other edible liquid.

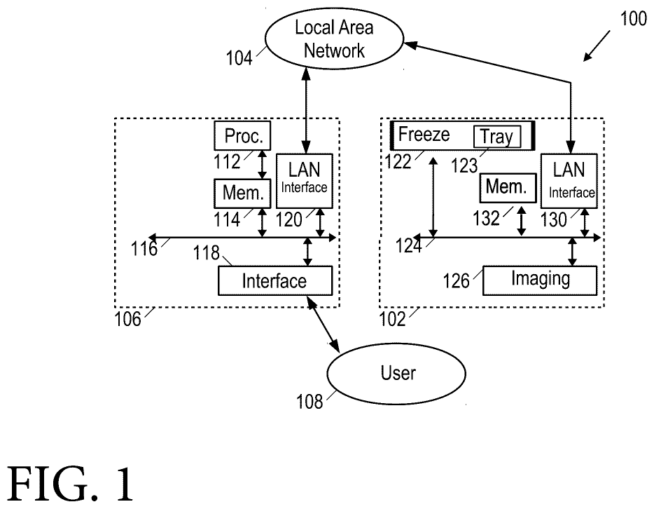

Turning to FIG. 1, a system 100 includes an imaging system 126 and a freezing chamber 122 coupled to the imaging system 126. The freezing chamber 122 includes a tray 123. Here, the freezing chamber 122 and imaging system 126 are coupled 124 and housed in the same housing 102, but in at least one embodiment the imaging system 126 may not be housed within the same housing as the freezing chamber 122. In other embodiments, the imaging system 126 may be housed within the freezing chamber 122 itself.

The freezing chamber 122 creates ice from water by freezing the water in the tray 123, and the imaging system 126 physically places an image into the ice during the ice creation process. In this way, the ice includes the image. The image placed into the ice may include edible ink and/or edible paper, both not having a taste in at least one embodiment. As such, the flavor of any drink containing the resulting ice will not be affected. Alternatively, edible liquid or paper may impart a taste such as sweetness via sugar or artificial sweetener. The image may be a watermark or logo, and may be single-colored, multi-colored, or transparent. The imaging system 126 may also include a means of adjusting the size and position of the image within the ice so that the image appears in the desired location and size. For example, sensors and motors may be used to move the image or tray 123 to a precisely targeted area. The freezing chamber 122 and tray 123 may be adjusted to create ice in different shapes, sizes, and thicknesses and this may be directed by the control module 106.

The system 100 may include a control module 106 coupled to the imaging system 126, and the control module 106 may upload the image to the imaging system 126. For example, a user 108 may select and upload the image using the control module 106. The control module 106 may include a wireless device such as a mobile device or a touch screen display that allows the user 108 to upload images from different sources such as a local storage 114 or the world wide web. In another embodiment, the user 108 may select images directly from local storage 132 within the housing 102. The control module 106 may include a processor 112, memory coupled to the processor 114, a user interface 118, and a LAN interface 120 for coupling with a local area network 104. The network 104 may be coupled to another LAN interface 130 that provides connectivity to the imaging system 126 and freezing chamber 122. The imaging system 126 may be coupled 124 to memory 132 for storing images for later use, and the imaging system 126 may also include a local processor.

The freezing chamber 122 may be coupled to the control module 106 and the control module 106 may direct the freezing chamber 122 to create the ice in a certain shape. For example, the freezing chamber 122 may be directed to use a particular tray 123 among many trays, change the shape of the tray, change the water directed into the tray, change the freezing routine, change the freezing parameters and the like. Additionally, the imaging system 126 may include a means of automating the image insertion process to insert specific images at certain times or in response to certain conditions, such as date, time, temperature, and the like. This allows for greater convenience and ease of use for the user 108. For example, in December, Christmas cubes can be made with seasonal images such as Christmas trees, stars, Santa Claus, reindeer, presents, snowflakes, and the like. Similarly, Thanksgiving cubes can be made with images such as turkeys, pilgrims, pumpkins, maple leaves, and the like. Halloween cubes may include ghosts, skulls, cats, witches hat, and the like. Valentine's Day cubes may include hearts and the like. Other themed cubes sets may include images pertaining to money, emoji, and the like. Finally custom cubes may include initials, names, pertinent dates (birthdays, anniversaries), and the like.

The freezing chamber 122 may freeze half of the ice prior to the imaging system 126 placing the image into the ice or tray 123, and the freezing chamber 122 may freeze half of the ice after the imaging system 126 places the image into the ice. The imagining system 126 may physically place multiple images within a single piece of ice or use multiple images to create a three-dimensional image in the ice by adjusting the depth and thickness of the images.

The imaging system 126 may include a printer, which prints the image and automatically, without human input, feeds it directly into the tray. This printer may be wirelessly connected to the control module 106 that uploads the image and directs the imaging process. The system 100 may also be integrated into a vending machine for automated operation, including image upload, payment processing, and ice dispensing (with or without the corresponding beverage), with options for manual or automatic delivery of the imaged ice.

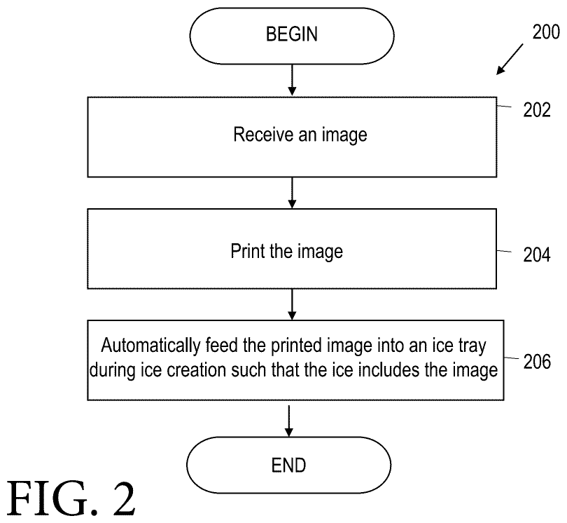

Turning to FIG. 2, a method 200 of ice creation is disclosed. The method 200 may include any step described herein. The method 200 includes receiving 202 an image. Receiving the image may include receiving the image uploaded by a control module, and the control module may include a wireless device. For example, a user may select and upload the image using a phone as the control module. As such, receiving the image may include receiving the image via wireless network.

The method 200 further includes printing 204 the image. Printing the image may include printing the image using edible ink, edible paper, and the like. The image may be a watermark or logo, and the image may single-colored, multi-colored, or transparent in various embodiments. Printing the image may include printing the image outside of the freezing chamber, and the image may not have a taste in at least one embodiment.

The method 200 further includes automatically, without human input, feeding 206 the printed image into a tray, coupled to a freezing chamber that creates ice from water by freezing the water in the tray, during ice creation such that the ice includes the image. Feeding the image may include physically inserting the image on top of frozen ice prior to ice freezing on top of the image. The method 200 may further include adjusting the size and position of the image within the ice or physically placing multiple images within a single piece of ice. The method 200 may further include creating a three-dimensional image in the ice by adjusting the depth and thickness of the image or storing the image for later use.

The method 200 may further include using a printer to print edible ink onto edible paper. In a manual embodiment, a user may place a paper image into the tray. After freezing, the user may serve the finished ice cubes. In another manual embodiment, a user may attach an image on edible paper to the ice using edible glue or adhesive that resists cold temperatures.

The printer need not be inside the freezing chamber; instead it may be adjacent to or attached to the freezing chamber. In this embodiment, a feed slot, allowing the imaged paper to be fed into the ice trays or directly onto the ice cubes, may be used. As such, the printer is kept at room temperature, preventing it from freezing, and insulation between the printer and freezing chamber may be used for added protection.

In alternative embodiments, the printer may feed the imaged paper to trays that are either full of water, partially frozen, or fully frozen, depending on the desired outcome. For example, trays with partially frozen water may be topped off with water before being frozen again to create ice cubes with embedded images. Larger images may also be attached to blocks of ice or ice sculptures using the same principles. Additionally, the image may be transmitted to the printer wirelessly or via a wired connection from a computer or mobile device (e.g. cellular phone or via a different type of wireless or hard-wired device). Also, the same image may be created on multiple ice cubes or portions of ice of varying shapes and sizes.

In various embodiments, the image may be placed in a liquid and then frozen or attached to the outside of the frozen material. For example, the image may be created in liquid water or placed on the outside of frozen ice thus accommodating small ice cubes or large blocks of frozen ice. Considering the latter, a wholesale ice maker may print the images on a large block of ice to fulfill a customer's request. For example, a life-size image of a person may be printed on a 6-foot tall block of ice for use as a standee, the image of a unicorn may be printed on a 3-foot tall block of ice, and all the images of children at a birthday party, including the birthday child, may be printed for their individual use. This versatile system allows for both manual and automatic application of imaged paper to ice, offering a wide range of possibilities for embedding images in ice cubes, blocks, or sculptures.

The method 200 may further include physically placing multiple images in a single piece of ice, using the image as a watermark or logo, or generating a series of images that create an animation when the ice is rotated. Additionally, the method include placing the image in ice such that the image remains hidden until the ice melts. In at least one embodiment, the image includes scannable codes, such as QR codes, or other scannable content that may be embedded in the ice and scanned while embedded.

In some aspects, apparatuses, systems, and methods for imaging during ice creation are provided according to one or more of the following examples:
Example 1: A system includes an imaging system, and a freezing chamber coupled to the imaging system. The system further includes a tray coupled to the freezing chamber. The freezing chamber creates ice from water by freezing the water in the tray, and the imaging system places an image into the tray during ice creation such that the ice includes the image.
Example 2: A method includes receiving a digital image and printing the digital image, thus creating a printed image. The method further includes automatically feeding the printed image into a tray. The tray is coupled to a freezing chamber that creates ice from water by freezing the water in the tray during ice creation such that the ice includes the image.
Example 3: A system includes a means for imaging and a means for freezing water coupled to the imaging means. The system further includes a means for holding water coupled to the freezing means. The freezing means creates ice from water by freezing the water in the holding means, and the imaging means places an image into the holding means during ice creation such that the ice includes the image.

The following features may be incorporated into the various embodiments described above, such features incorporated either individually in or conjunction with one or more of the other features: The image placed into the ice may include edible ink. The system may include a control module coupled to the imaging system, and the control module may upload the image to the imaging system. The imaging system is may not be housed within the freezing chamber in at least one embodiment. The image placed into the ice may include edible paper. The freezing chamber may freeze half of the ice prior to the imaging system placing the image into the ice, and the freezing chamber may freeze half of the ice after the imaging system places the image into the ice. The freezing chamber may be coupled to the control module and the control module may direct the freezing chamber to create the ice in a certain shape. The image may not have a taste in at least one embodiment. The control module may include a wireless device. A user may select and upload the image using the control module. The control module may be coupled to the imaging system via wireless network. The imaging system may store multiple images for later use. The control module may direct the imaging system to adjust the size and position of the image within the ice. The imagining system may physically place multiple images within a single piece of ice. The image may be a watermark or logo. The image may be multi-colored. The image may be transparent. The imaging system may create a three-dimensional image in the ice by adjusting the depth and thickness of the image. Printing the image may include printing the image using edible ink. Receiving the image may include receiving the image uploaded by a control module. Printing the image may include printing the image outside of the freezing chamber. Printing the image may include printing the image on edible paper. Physically inserting the image may include physically inserting the image on top of frozen ice prior to ice freezing on top of the image. The image does may not have a taste in at least one embodiment. The control module may include a wireless device. A user may select and upload the image using the control module. Receiving the image may include receiving the image via wireless network. The method may further include storing the image for later use. The method may further include adjusting the size and position of the image within the ice. The method may further include physically placing multiple images within a single piece of ice. The image may be a watermark or logo. The image may be multi-colored. The image may be transparent. The method may further include creating a three-dimensional image in the ice by adjusting the depth and thickness of the image.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein. Numerous other modifications, equivalents, and alternatives, will become apparent once the above disclosure is fully appreciated. It is intended that the following claims be interpreted to embrace all such modifications, equivalents, and alternatives where applicable.

What is claimed is:

1. A system, comprising:
an imaging system;
a freezing chamber coupled to the imaging system; and
a tray coupled to the freezing chamber;
wherein the freezing chamber creates ice from water by freezing the water in the tray; and
wherein the imaging system places an image into the tray during ice creation such that the ice comprises the image.

2. The system of claim 1, wherein the imaging system comprises a printer, the printer prints the image, and the image is fed from the printer into the tray.

3. The system of claim 2, wherein the printer is wirelessly coupled to a wireless device, and wherein a digital version of the image is uploaded to the printer via the wireless device.

4. The system of claim 2, wherein the image is fed into the tray onto the surface of the ice.

5. The system of claim 3, wherein the wireless device directs the imaging system to adjust the size and position of the image within the tray.

6. The system of claim 1, wherein the imaging system creates a three-dimensional image in the ice by adjusting the depth and thickness of the image placed into the tray.

7. The system of claim 2, wherein the image is fed into the tray into the water.

8. The system of claim 1, wherein the freezing chamber and imaging system are housed within a vending machine that receives a digital version of the image from a wireless device, accepts payment for the ice, and dispenses the ice.

9. The system of claim 1, wherein the image is part of a plurality of images that creates an animation as the ice is turned.

10. The system of claim 1, wherein the tray is a mold and wherein the ice is selected from a group consisting of: beverage ice cubes, blocks of ice, and ice sculptures.

11. The system of claim 1, wherein the image comprises pull and stick paper.

12. A method, comprising:
receiving a digital image;
printing the digital image, thus creating a printed image; and
automatically feeding the printed image into a tray, coupled to a freezing chamber that creates ice from water by freezing the water in the tray, during ice creation such that the ice comprises the image.

13. The method of claim 12, wherein receiving the digital image comprises receiving the digital image wirelessly from a wireless device.

14. The method of claim 12, further comprising storing multiple digital images for later use.

15. The method of claim 13, further comprising receiving instructions to adjust the size and position of the printed image within the tray.

16. The method of claim 12, further comprising adjusting the depth and thickness of the printed image in the tray to create a three-dimensional image in the ice.

17. The method of claim 12, wherein the image comprises edible ink, edible adhesive, and edible paper.

18. The method of claim 12, further comprising receiving the digital image from a wireless device, accepting payment for the ice, and dispensing the ice.

19. The method of claim 12, further comprising using the digital image to create a plurality of digital images that create an animation as the ice is turned.

20. A system, comprising:
a means for imaging;
a means for freezing water coupled to the imaging means; and
a means for holding water coupled to the freezing means;
wherein the freezing means creates ice from water by freezing the water in the holding means; and
wherein the imaging means places an image into the holding means during ice creation such that the ice comprises the image.
